(19) United States
(12) Patent Application Publication
(10) Pub. No.: US 2018/0267615 A1
(43) Pub. Date: Sep. 20, 2018

(54) GESTURE-BASED GRAPHICAL KEYBOARD FOR COMPUTING DEVICES

(71) Applicant: DAQRI, LLC, Los Angeles, CA (US)

(72) Inventors: Jonathan Trevor Freeman, Los Angeles, CA (US); Michael Kozlowski, Los Angeles, CA (US); Noopur Gupta, San Jose, CA (US); Anthony L. Reyes, San Jose, CA (US); Neil Aalto, Lahaina, HI (US)

(21) Appl. No.: 15/464,194

(22) Filed: Mar. 20, 2017

(51) Int. Cl. G06F 3/01; G06F 3/0482; G06F 3/0346

(52) U.S. Cl. CPC G06F 3/017; G06F 3/0346; G06F 3/0482

(57) ABSTRACT

A computing device provides augmented reality images of an environment in which the computing device is worn. The computing device is further configured to display a graphical keyboard for interacting with the computing device. The graphical keyboard may be displayed according to one or more configured keyboard layouts. The computing device further includes an inertial measurement unit, which provides input for manipulating the graphical keyboard. As a user of the computing device moves his or her body, or a portion thereof, corresponding graphical changes are made to the displayed graphical keyboard. In this way, by moving his or her body (or a portion thereof), the user is able to interact with, and provide input to, the computing device.

### TECHNICAL FIELD

The subject matter disclosed herein generally relates to a gesture-based graphical keyboard for computing devices and, in particular, to interpreting gestures and/or movements by a user as input for a graphical keyboard displayed on a computing device.

### BACKGROUND

Augmented reality (AR) is a live direct or indirect view of a physical, real-world environment whose elements are augmented (or supplemented) by computer-generated sensory input such as sound, video, graphics or Global Positioning System (GPS) data. With the help of advanced AR technology (e.g., adding computer vision and object recognition) the information about the surrounding real world of the user becomes interactive. Device-generated (e.g., artificial) information about the environment and its objects can be overlaid on the real world.

Typically, a user uses a computing device to view the augmented reality. The computing device may be equipped with an input device, such as a software-based or hardware-based keyboard, for providing input to, and controlling, the computing device. However, where the computing device is a computing device, there are particular challenges in implementing a keyboard for controlling the computing device. Accordingly, a more convenient input method is needed.

### BRIEF DESCRIPTION OF THE DRAWINGS

Some embodiments are illustrated by way of example and not limited to the figures of the accompanying drawings.

FIG. 1 is a block diagram illustrating an example of a network environment suitable for a computing device, according to an example embodiment.

FIG. 2 is a block diagram of the computing device of FIG. 1, according to an example embodiment.

FIG. 3 is a block diagram illustrating different types of sensors used by the computing device of FIG. 1, according to an example embodiment.

FIG. 4 illustrates an example of a graphical keyboard implemented by the computing device of FIG. 1, according to an example embodiment.

FIGS. 5A-5B illustrate alternative examples of graphical keyboards implemented by the computing device of FIG. 1, according to example embodiments.

FIGS. 6A-6C illustrate another example of a graphical keyboard implemented by the computing device of FIG. 1, according to example embodiments

FIG. 7 illustrates another example of a graphical keyboard implemented by the computing device of FIG. 1, according to an example embodiment.

FIG. 8 illustrates a method, according to an example embodiment, implemented by the computing device of FIG. 1 for interpreting gestures and movements for a displayed graphical keyboard.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

This disclosure provides for a computing device that displays a graphical keyboard, which is controllable via gestures and/or movements by a user of the computing device. The graphical keyboard displayed by the computing device may be displayed in various configurations including, but not limited to, a linear configuration, a vertically compact configuration, a horizontally compact configuration, and a circularly rotational configuration. The displayed graphical keyboard may further include colored indicators, or other graphical objects, that indicate various positions and/or characters along the graphical keyboard. Using the displayed graphical keyboard, the user is able to provide textual input to, and/or control, the computing device.

Accordingly, this disclosure discloses a computing device that includes a machine-readable memory storing computer-executable instructions and at least one hardware processor in communication with the machine-readable memory that, when the computer-executable instructions are executed, configures a computing device to perform a plurality of operations. The plurality of operations include displaying, on a transparent display physically coupled with at least one hardware processor, a graphical keyboard, the graphical keyboard having at least one selectable alphanumeric character, acquiring, by at least one inertial measurement unit, a plurality of measurements indicating user movement of the computing device, and converting, by the at least one hardware processor, the plurality of measurements to obtain a plurality of vectors, at least one vector of the plurality of vectors associated with at least three axes of movement. The plurality of operations also include determining, by the at least one hardware processor, and based on the plurality of vectors, a command to perform with the displayed graphical keyboard, and performing, by the at least one hardware processor, the determined command with the displayed graphical keyboard.

In another embodiment of the computing device, the plurality of operations further comprises comparing one or more values of the plurality of vectors with a plurality of corresponding thresholds, at least one of the thresholds selected from the plurality of thresholds associated with the command to perform, and the determining of the command to perform is further based on the comparison.

In a further embodiment of the computing device, the command to perform comprises a command to select the at least one selectable alphanumeric character.

In yet another embodiment of the computing device, the command to perform comprises a command to submit the at least one selectable alphanumeric character, and the plurality of operations further comprises displaying the submitted at least one selectable alphanumeric character at a predetermined location of the graphical keyboard.

In yet a further embodiment of the computing device, the displayed graphical keyboard comprises a horizontal arrangement of alphanumeric characters, the horizontal arrangement of alphanumeric characters being substantially parallel to a ground plane, and at least one control element that indicates whether the user intends to submit the at least one selectable alphanumeric character for display on the transparent display physically coupled with at least one hardware processor.

In another embodiment of the computing device, the displayed graphical keyboard comprises a first plurality of alphanumeric characters, the first plurality of alphanumeric characters being a subset selected from a second plurality of alphanumeric characters, wherein each alphanumeric character of the first plurality of alphanumeric characters is displayed in a font size based on a relative position of the alphanumeric character, and an indicator element that indicates an alphanumeric character selected from the first plurality of alphanumeric characters to be a submitted alphanumeric character, wherein the indicator element is associated with a predetermined position where the first plurality of alphanumeric characters are displayed.

In a further embodiment of the computing device, the displayed graphical keyboard comprises an elliptical arrangement of a plurality of alphanumeric characters, wherein a first position of the elliptical arrangement is associated with a largest font size and a second position is associated with a smallest font size, each alphanumeric character of the plurality of alphanumeric characters is displayed at a two-dimensional coordinate relative to the transparent display physically coupled with at least one hardware processor, a first alphanumeric character of the plurality of alphanumeric characters is displayed with the largest font size at the first position, a second alphanumeric character of the plurality of alphanumeric characters is displayed with the smallest font size at the second position, and a set of alphanumeric characters selected from the plurality of alphanumeric characters, where each alphanumeric characters of the set is displayed with a font size having a value between the smallest font size and the largest font size.

This disclosure also provides for a method that includes displaying, on a display in communication with at least one hardware processor, a graphical keyboard, the graphical keyboard having at least one selectable alphanumeric character, acquiring, by at least one inertial measurement unit, a plurality of measurements indicating user movement of the computing device, and converting, by the at least one hardware processor, the plurality of measurements to obtain a plurality of vectors, at least one vector of the plurality of vectors associated with at least three axes of movement. The method further includes determining, by the at least one hardware processor, and based on the plurality of vectors, a command to perform with the displayed graphical keyboard, and performing, by the at least one hardware processor, the determined command with the displayed graphical keyboard.

In another embodiment of the method, the method includes comparing one or more values of the plurality of vectors with a plurality of corresponding thresholds, at least one of the thresholds selected from the plurality of thresholds being associated with the command to perform, and the determining of the command to perform is further based on the comparison.

In a further embodiment of the method, the command to perform comprises a command to select the at least one selectable alphanumeric character.

In yet another embodiment of the method, the command to perform comprises a command to submit the at least one selectable alphanumeric character, and the method further comprises displaying the submitted at least one selectable alphanumeric character at a predetermined location of the graphical keyboard.

In yet a further embodiment of the method, the displayed graphical keyboard comprises a horizontal arrangement of alphanumeric characters, the horizontal arrangement of alphanumeric characters being substantially parallel to a ground plane, and at least one control element that indicates whether the user intends to submit the at least one selectable alphanumeric character for display on the transparent display physically coupled with at least one hardware processor.

In another embodiment of the method, the displayed graphical keyboard comprises a first plurality of alphanumeric characters, the first plurality of alphanumeric characters being a subset selected from a second plurality of alphanumeric characters, wherein each alphanumeric character of the first plurality of alphanumeric character is displayed in a font size based on a relative position of the alphanumeric character, and an indicator element that indicates an alphanumeric character selected from the first plurality of alphanumeric characters to be a submitted alphanumeric character, wherein the indicator element is associated with a predetermined position where the first plurality of alphanumeric characters are displayed.

In a further embodiment of the method, the displayed graphical keyboard comprises an elliptical arrangement of a plurality of alphanumeric characters, wherein a first position of the elliptical arrangement is associated with a largest font size and a second position is associated with a smallest font size, each alphanumeric character of the plurality of alphanumeric characters is displayed at a two-dimensional coordinate relative to the transparent display physically coupled with at least one hardware processor, a first alphanumeric character of the plurality of alphanumeric characters is displayed with the largest font size at the first position, a second alphanumeric character of the plurality of alphanumeric characters is displayed with the smallest font size at the second position, and a set of alphanumeric characters selected from the plurality of alphanumeric characters, where each alphanumeric character of the set is displayed with a font size having a value between the smallest font size and the largest font size.

This disclosure also describes a computer-readable medium having computer-executable instructions stored thereon that, when executed by at least one hardware processor, causes a computing device to perform a plurality of operations. In one embodiment, the plurality of operations include displaying, on a transparent display physically coupled with at least one hardware processor, a graphical keyboard, the graphical keyboard having at least one selectable alphanumeric character, acquiring, by at least one inertial measurement unit, a plurality of measurements indicating user movement of the computing device, and converting, by the at least one hardware processor, the plurality of measurements to obtain a plurality of vectors, at least one vector of the plurality of vectors associated with at least three axes of movement. The plurality of operations also include determining, by the at least one hardware processor, and based on the plurality of vectors, a command to perform with the displayed graphical keyboard, and performing, by the at least one hardware processor, the determined command with the displayed graphical keyboard.

In another embodiment of the computer-readable medium, the plurality of operations further comprises comparing one or more values of the plurality of vectors with a plurality of corresponding thresholds, at least one of the thresholds selected from the plurality of thresholds being associated with the command to perform, and the determining of the command to perform is further based on the comparison.

In a further embodiment of the computer-readable medium, the command to perform comprises a command to submit the at least one selectable alphanumeric character, and the plurality of operations further comprises displaying the submitted at least one selectable alphanumeric character at a predetermined location of the graphical keyboard.

In yet another embodiment of the computer-readable medium, the displayed graphical keyboard comprises a horizontal arrangement of alphanumeric characters, the horizontal arrangement of alphanumeric characters being substantially parallel to a ground plane, and at least one control element that indicates whether the user intends to submit the at least one selectable alphanumeric character for display on the transparent display physically coupled with at least one hardware processor.

In yet a further embodiment of the computer-readable medium, the displayed graphical keyboard includes a first plurality of alphanumeric characters, the first plurality of alphanumeric characters being a subset selected from a second plurality of alphanumeric characters, wherein each alphanumeric character of the first plurality of alphanumeric character is displayed in a font size based on a relative position of the alphanumeric character, and an indicator element that indicates an alphanumeric character selected from the first plurality of alphanumeric characters to be a submitted alphanumeric character, wherein the indicator element is associated with a predetermined position where the first plurality of alphanumeric characters are displayed.

In another embodiment of the computer-readable medium, the displayed graphical keyboard includes an elliptical arrangement of a plurality of alphanumeric characters, wherein a first position of the elliptical arrangement is associated with a largest font size and a second position is associated with a smallest font size, each alphanumeric character of the plurality of alphanumeric characters is displayed at a two-dimensional coordinate relative to the transparent display physically coupled with at least one hardware processor, a first alphanumeric character of the plurality of alphanumeric characters is displayed with the largest font size at the first position, a second alphanumeric character of the plurality of alphanumeric characters is displayed with the smallest font size at the second position, and a set of alphanumeric characters selected from the plurality of alphanumeric characters, where each alphanumeric character is displayed with a font size having a value between the smallest font size and the largest font size.

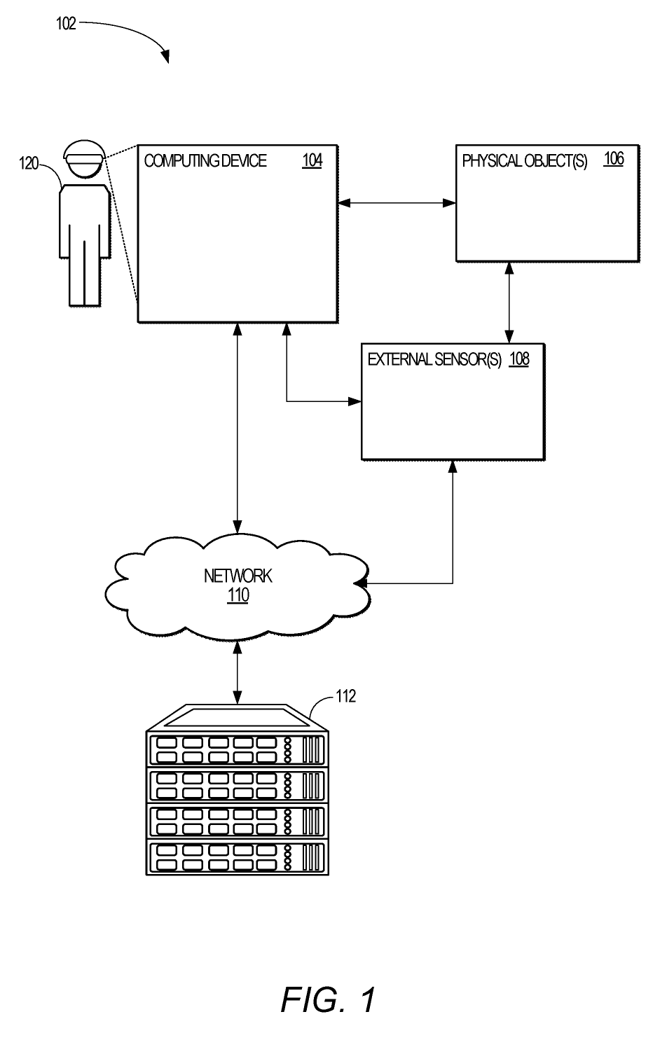

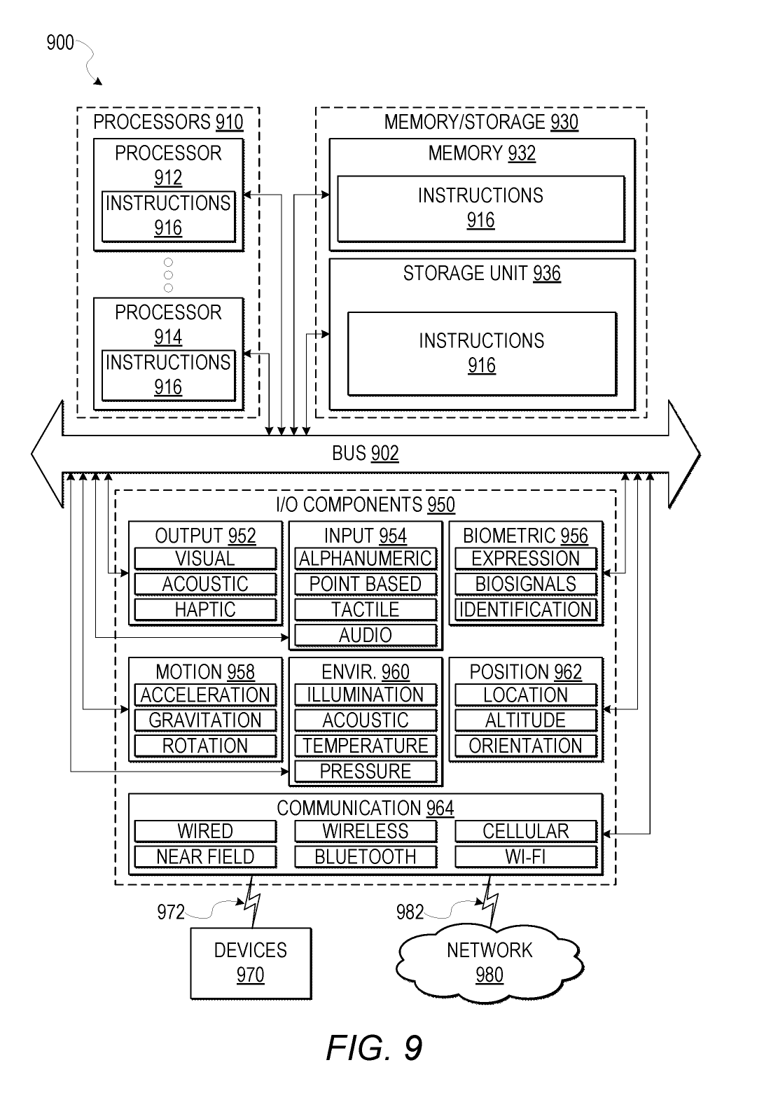

FIG. 1 is a block diagram illustrating an example of a network environment 102 suitable for a computing device 104, according to an example embodiment. The network environment 102 includes the computing device 104 and a server 112 communicatively coupled to each other via a network 110. The computing device 104 and the server 112 may each be implemented in a computer system, in whole or in part, as described below with respect to FIG. 9.

The server 112 may be part of a network-based system. For example, the network-based system may be or include a cloud-based server system that provides additional information, such as three-dimensional (3D) models or other virtual objects, to the computing device 104.

The computing device 104 may be implemented in various form factors. In one embodiment, the computing device 104 is implemented as a helmet, which the user 120 wears on his or her head, and views objects (e.g., physical object(s) 106) through a display device, such as one or more lenses, affixed to the computing device 104. In another embodiment, the computing device 104 is implemented as a lens frame, where the display device is implemented as one or more lenses affixed thereto. In yet another embodiment, the computing device 104 is implemented as a watch (e.g., a housing mounted or affixed to a wrist band), and the display device is implemented as a display (e.g., liquid crystal display (LCD) or light emitting diode (LED) display) affixed to the computing device 104.

A user 120 may wear the computing device 104 and view one or more physical object(s) 106 in a real-world physical environment. The user 120 may be a human user (e.g., a human being), a machine user (e.g., a computer configured by a software program to interact with the computing device 104), or any suitable combination thereof (e.g., a human assisted by a machine or a machine supervised by a human). The user 120 is not part of the network environment 102, but is associated with the computing device 104. For example, the computing device 104 may be a computing device with a camera and a transparent display. In another example embodiment, the computing device 104 may be hand-held or may be removably mounted to the head of the user 120. In one example, the display device may include a screen that displays what is captured with a camera of the computing device 104. In another example, the display may be transparent or semi-transparent, such as lenses of wearable computing glasses or the visor or a face shield of a helmet.

The user 120 may be a user of an augmented reality (AR) application executable by the computing device 104 and/or the server 112. The AR application may provide the user 120 with an AR experience triggered by one or more identified objects (e.g., physical object(s) 106) in the physical environment. For example, the physical object(s) 106 may include identifiable objects such as a two-dimensional (2D) physical object (e.g., a picture), a 3D physical object (e.g., a factory machine), a location (e.g., at the bottom floor of a factory), or any references (e.g., perceived corners of walls or furniture) in the real-world physical environment. The AR application may include computer vision recognition to determine various features within the physical environment such as corners, objects, lines, letters, and other such features or combination of features.

In one embodiment, the objects in an image captured by the computing device 104 are tracked and locally recognized using a local context recognition dataset or any other previously stored dataset of the AR application. The local context recognition dataset may include a library of virtual objects associated with real-world physical objects or references. In one embodiment, the computing device 104 identifies feature points in an image of the physical object 106. The computing device 104 may also identify tracking data related to the physical object 106 (e.g., GPS location of the computing device 104, orientation, or distance to the physical object(s) 106). If the captured image is not recognized locally by the computing device 104, the computing device 104 can download additional information (e.g., 3D model or other augmented data) corresponding to the captured image, from a database of the server 112 over the network 110.

In another example embodiment, the physical object(s) 106 in the image is tracked and recognized remotely by the server 112 using a remote context recognition dataset or any other previously stored dataset of an AR application in the server 112. The remote context recognition dataset may include a library of virtual objects or augmented information associated with real-world physical objects or references.

The network environment 102 also includes one or more external sensors 108 that interact with the computing device 104 and/or the server 112. The external sensors 108 may be associated with, coupled to, or related to the physical object(s) 106 to measure a location, status, and characteristics of the physical object(s) 106. Examples of measured readings may include but are not limited to weight, pressure, temperature, velocity, direction, position, intrinsic and extrinsic properties, acceleration, and dimensions. For example, external sensors 108 may be disposed throughout a factory floor to measure movement, pressure, orientation, and temperature. The external sensor(s) 108 can also be used to measure a location, status, and characteristics of the computing device 104 and the user 120. The server 112 can compute readings from data generated by the external sensor(s) 108. The server 112 can generate virtual indicators such as vectors or colors based on data from external sensor(s) 108. Virtual indicators are then overlaid on top of a live image or a view of the physical object(s) 106 (e.g., displayed on a display device) in a line of sight of the user 120 to show data related to the physical object(s) 106. For example, the virtual indicators may include arrows with shapes and colors that change based on real-time data. Additionally and/or alternatively, the virtual indicators are rendered at the server 112 and streamed to the computing device 104.

The external sensor(s) 108 may include one or more sensors used to track various characteristics of the computing device 104 including, but not limited to, the location, movement, and orientation of the computing device 104 externally without having to rely on sensors internal to the computing device 104. The external senor(s) 108 may include optical sensors (e.g., a depth-enabled 3D camera), wireless sensors (e.g., Bluetooth, Wi-Fi), Global Positioning System (GPS) sensors, and audio sensors to determine the location of the user 120 wearing the computing device 104, distance of the user 120 to the external sensor(s) 108 (e.g., sensors placed in corners of a venue or a room), the orientation of the computing device 104 to track what the user 120 is looking at (e.g., direction at which a designated portion of the computing device 104 is pointed, e.g., the front portion of the computing device 104 is pointed towards a player on a tennis court).

Furthermore, data from the external senor(s) 108 and internal sensors (not shown) in the computing device 104 may be used for analytics data processing at the server 112 (or another server) for analysis on usage and how the user 120 is interacting with the physical object(s) 106 in the physical environment. Live data from other servers may also be used in the analytics data processing. For example, the analytics data may track at what locations (e.g., points or features) on the physical object(s) 106 or virtual object(s) (not shown) the user 120 has looked, how long the user 120 has looked at each location on the physical object(s) 106 or virtual object(s), how the user 120 wore the computing device 104 when looking at the physical object(s) 106 or virtual object(s), which features of the virtual object(s) the user 120 interacted with (e.g., such as whether the user 120 engaged with the virtual object), and any suitable combination thereof. To enhance the interactivity with the physical object(s) 106 and/or virtual objects, the computing device 104 receives a visualization content dataset related to the analytics data. The computing device 104 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 110 may be any network that facilitates communication between or among machines (e.g., server 110), databases, and devices (e.g., the computing device 104 and the external sensor(s) 108). Accordingly, the network 110 may be a wired network, a wireless network (e.g., a mobile or cellular network), or any suitable combination thereof. The network 110 may include one or more portions that constitute a private network, a public network (e.g., the Internet), or any suitable combination thereof.

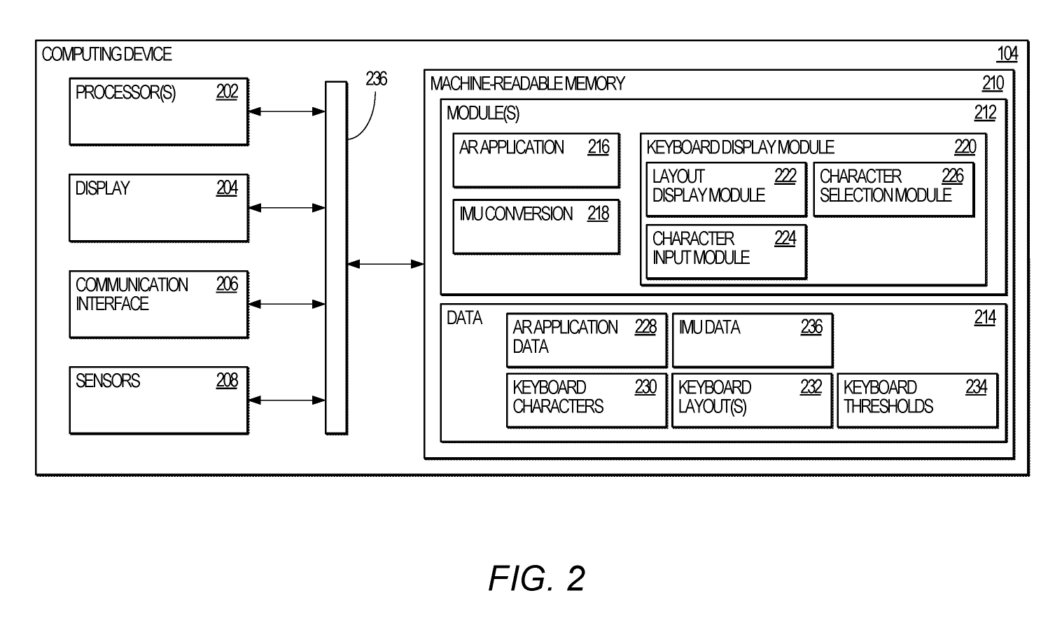

FIG. 2 is a block diagram of the computing device 104 of FIG. 1, according to an example embodiment. The computing device 104 includes various different types of hardware components. In one embodiment, the computing device 104 includes one or more processor(s) 202, a display 204, a communication interface 206, and one or more sensors 208. The computing device 104 also includes a machine-readable memory 210. The various components 202-210 communicate via a communication bus 236.

The one or more processors 202 may be any type of commercially available processor, such as processors available from the Intel Corporation, Advanced Micro Devices, Qualcomm, Texas Instruments, or other such processors. Further still, the one or more processors 202 may include one or more special-purpose processors, such as a Field-Programmable Gate Array (FPGA) or an Application Specific Integrated Circuit (ASIC). The one or more processors 202 may also include programmable logic or circuitry that is temporarily configured by software to perform certain operations. Thus, once configured by such software, the one or more processors 202 become specific machines (or specific components of a machine) uniquely tailored to perform the configured functions and are no longer general-purpose processors.

The display 204 may include a display surface or lens configured to display AR content (e.g., images, video) generated by the one or more processor(s) 202. In one embodiment, the display 204 is made of a transparent material (e.g., glass, plastic, acrylic, etc.) so that the user 120 can see through the display 204. In another embodiment, the display 204 is made of several layers of a transparent material, which creates a diffraction grating within the display 204 such that images displayed on the display 204 appear holographic. In one embodiment, the display 204 is physically coupled with the processor(s) 202. The physical coupling between the display 204 and the processor(s) 202 may be a direct physical coupling, where one or more wires and/or copper traces are established between the display 204 and the processor(s) 202. The physical coupling between the display 204 and the processor(s) 202 may also be an indirect physical coupling, where one or more intervening devices are established between the display 204 and the processor(s) 202. In addition, the display 204 and the processor(s) 202 may be housed within the same physical housing. The processor(s) 202 are configured to display a user interface on the display 204 so that the user 120 can interact with the computing device 104.

The communication interface 206 is configured to facilitate communications between the computing device 104, the user 120, the external sensor(s) 108, and the server 112. The communication interface 206 may include one or more wired communication interfaces (e.g., Universal Serial Bus (USB), an I²C bus, an RS-232 interface, an RS-485 interface, etc.), one or more wireless transceivers, such as a Bluetooth® transceiver, a Near Field Communication (NFC) transceiver, an 802.11x transceiver, a 3G (e.g., a GSM and/or CDMA) transceiver, a 4G (e.g., LTE and/or Mobile WiMAX) transceiver, or combinations of wired and wireless interfaces and transceivers. In one embodiment, the communication interface 206 interacts with the sensors 208 to provide input to the computing device 104. In this embodiment, the user 120 may engage in gestures, eye movements, speech, or other physical activities that the computing device 104 interprets as input (e.g., via the AR application 216).

To detect the movements of the user 120, the computing device 104, and/or other objects in the environment, the computing device 104 includes one or more sensors 208. The sensors 208 may generate internal tracking data of the computing device 104 to determine a position and/or an orientation of the computing device 104. In addition, the sensors 208 cooperatively operate to assist the computing device 104 in identifying objects and obtaining thermal imagery for objects within the environment where the computing device 104 is located.

The position and the orientation of the computing device 104 may be used to identify real-world objects in a field of view of the computing device 104. For example, a virtual object may be rendered and displayed in the display 204 when the sensors 208 indicate that the computing device 104 is oriented towards a real-world object (e.g., when the user 120 looks at one or more physical object(s) 106) or in a particular direction (e.g., when the user 120 tilts his head to watch his wrist).

The computing device 104 may display a virtual object in response to a determined geographic location of the computing device 104. For example, a set of virtual objects may be accessible when the user 120 of the computing device 104 is located in a particular building. In another example, virtual objects, including sensitive material, may be accessible when the user 120 of the computing device 104 is located within a predefined area associated with the sensitive material and the user 120 is authenticated. Different levels of content of the virtual objects may be accessible based on a credential level of the user 120. For example, a user who is an executive of a company may have access to more information or content in the virtual objects than a manager at the same company. The sensors 208 may be used to authenticate the user 120 prior to providing the user 120 with access to the sensitive material (e.g., information displayed as a virtual object, such as a virtual dialog box, in a transparent display). Authentication may be achieved via a variety of methods such as providing a password or an authentication token or using sensors 208 to determine biometric data unique to the user 120.

The computing device 104 is further configured to display a gesture-based graphical keyboard that the user uses to provide input to the computing device 104. Accordingly, in one embodiment, the computing device 104 is configured with a keyboard display module 220 that displays a graphical keyboard via the display 204. The keyboard display module 220 may further accept input via movements by the user 120 and detected by an inertial measurement unit (IMU) of the sensors 208. As discussed below, the keyboard display module 220 may further include various sub- or internal modules 220-224 to facilitate the display of the graphical keyboard and the interpretation of input as provided by the user 120.

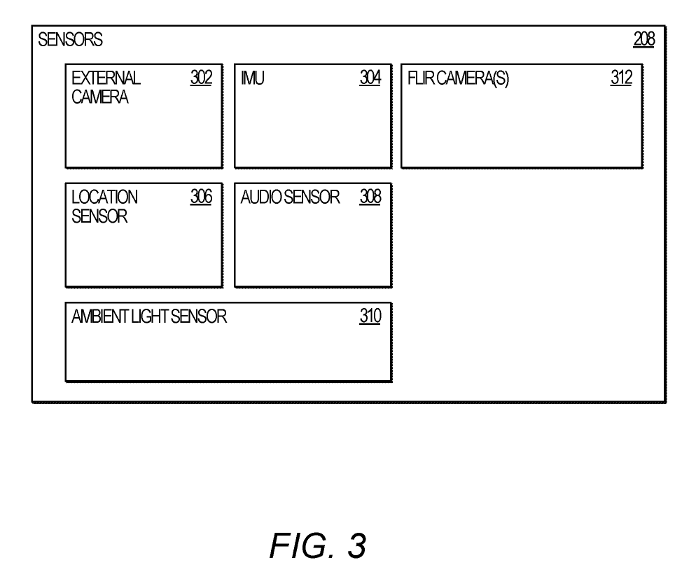

FIG. 3 is a block diagram illustrating different types of sensors 208 used by the computing device 104 of FIG. 1, according to an example embodiment. For example, the sensors 208 may include an external camera 302, an inertial measurement unit (IMU) 304, a location sensor 306, an audio sensor 308, an ambient light sensor 310, and one or more forward-looking infrared (FLIR) camera(s) 312. One of ordinary skill in the art will appreciate that the sensors 208 illustrated in FIG. 3 are examples, and that different types and/or combinations of sensors may be employed in the computing device 104.

The external camera 302 includes an optical sensor(s) (e.g., camera) configured to capture images across various spectrums. For example, the external camera 302 may include an infrared camera or a full-spectrum camera. The external camera 302 may include a rear-facing camera(s) and a front-facing camera(s) disposed in the computing device 104. The front-facing camera(s) may be used to capture a front field of view of the computing device 104 while the rear-facing camera(s) may be used to capture a rear field of view of the computing device 104. The pictures captured with the front- and rear-facing cameras may be combined to recreate a 360-degree view of the physical environment around the computing device 104.

The IMU 304 may include a gyroscope and an inertial motion sensor to determine an orientation and/or movement of the computing device 104. For example, the IMU 304 may measure the velocity, orientation, and gravitational forces on the computing device 104. The IMU 304 may also measure acceleration using an accelerometer and changes in angular rotation using a gyroscope The IMU 304 may be implemented using a digital and/or analog accelerometer, where the digital accelerometer communicates information using a serial protocol such as I²C, Serial Peripheral Interface (SPI), or Universal Synchronous/Asynchronous Receiver/Transmitter (USART). An analog accelerator may output a voltage level within a predefined range that can be converted to a digital value using an analog-to-digital converter (ADC), as is known to one of ordinary skill in the art.

In one embodiment, and as discussed further below, the computing device 104 may be further configured with an IMU conversion module 218 that converts the measurements and/or readings obtained by the IMU 304 into values interpretable by the keyboard display module 220. Thus, the outputs generated by the IMU 304 are usable as inputs to the keyboard display module 220, which inform the keyboard display module 220 as to which alphanumeric characters the user 120 has selected in interacting with the graphical keyboard displayed by the keyboard display module 220. In one embodiment, the measurements output by the IMU 304 include six different values, which indicate acceleration and orientation in three-dimensions or, more particularly, acceleration and orientation in one of three axes, such as the X-axis, Y-axis, and Z-axis. As one of ordinary skill in the art would understand, the output by the IMU 304 may be raw data, such as a voltage or a numerical value, which the IMU conversion module 218 converts to one or more interpretable values for use by the keyboard display module 220.

The location sensor 306 may determine a geolocation of the computing device 104 using a variety of techniques such as near field communication (NFC), the Global Positioning System (GPS), Bluetooth®, Wi-Fi®, and other such wireless technologies or combination of wireless technologies. For example, the location sensor 306 may generate geographic coordinates and/or an elevation of the computing device 104.

The audio sensor 308 may include one or more sensors configured to detect sound, such as a dynamic microphone, condenser microphone, ribbon microphone, carbon microphone, and other such sound sensors or combinations thereof. For example, the microphone may be used to record a voice command from the user (e.g., user 120) of the computing device 104. In other examples, the microphone may be used to measure an ambient noise (e.g., measure intensity of the background noise, identify specific type of noises such as explosions or gunshot noises).

The ambient light sensor 310 is configured to determine an ambient light intensity around the computing device 104. For example, the ambient light sensor 310 measures the ambient light in a room in which the computing device 104 is located. Examples of the ambient light sensor 310 include, but are not limited to, the ambient light sensors available from ams AG, located in Oberpremstatten, Austria.

The one or more FLIR camera(s) 312 are configured to capture and/or obtain thermal imagery of objects being viewed by the computing device 104 (e.g., by the external camera 302). One of ordinary skill in the art will appreciate that the FLIR camera(s) 312 illustrated in FIG. 3 and described below are examples, and that different types and/or combinations of infrared imaging devices may be employed in the computing device 104.

The FLIR camera(s) 312 may be affixed to different parts and/or surfaces of the computing device 104 depending upon its implementation. For example, where the computing device 104 is implemented as a head-mounted device, one or more of the FUR camera(s) 312 may be affixed or mounted in a forward-looking or rearward-looking position on an exterior or interior surface of the computing device 104. As another example, where the computing device 104 is implemented as a wrist-mounted device (e.g., a watch), one or more of the FUR camera(s) 312 may be affixed or disposed on a surface perpendicular to a surface having the display 204. In either examples, the one or more FLIR camera(s) 312 are arranged or disposed within the computing device 104 such that the FLIR camera(s) 312 obtain thermal imagery within the environment of the computing device 104.

Referring back to FIG. 2, the machine-readable memory 210 includes various modules 212 and data 214 for implementing the features of the computing device 104. The machine-readable memory 210 includes one or more devices configured to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable memory” should be taken to include a single medium or multiple media (e.g., a centralized or distributed database, or associated caches and servers) able to store the modules 212 and the data 214. Accordingly, the machine-readable memory 210 may be implemented as a single storage apparatus or device, or, alternatively and/or additionally, as “cloud-based” storage systems or storage networks that include multiple storage apparatus or devices. As shown in FIG. 2, the machine-readable memory 210 excludes signals per se.

In one embodiment, the modules 212 are written in a computer-programming and/or scripting language. Examples of such languages include, but are not limited to, C, C++, C#, Java, JavaScript, Perl, Python, Ruby, or any other computer programming and/or scripting language now known or later developed.

The modules 212 include one or more modules 216-226 that implement the features of the computing device 104. In one embodiment, the modules 212 include an AR application 216, the IMU conversion module 218, and the keyboard display module 220. The data 214 includes one or more different sets of data 228-234 used by, or in support of, the modules 212. In one embodiment, the data 214 includes AR application data 228, keyboard characters 230, keyboard layout(s) 232, keyboard thresholds 234, and IMU data 236.

The AR application 216 is configured to provide the user 120 with an AR experience triggered by one or more of the physical object(s) 106 in the user's 120 environment. Accordingly, the machine-readable memory 210 also stores AR application data 228 which provides the resources (e.g., sounds, images, text, and other such audiovisual content) used by the AR application 216. In response to detecting and/or identifying physical object(s) 106 in the user's 120 environment, the AR application 216 generates audiovisual content (e.g., represented by the AR application data 228) that is displayed on the display 204. To detect and/or identify the physical object(s) 106, the AR application 216 may employ various object recognition algorithms and/or image recognition algorithms.

The AR application 216 may further generate and/or display interactive audiovisual content on the display 204. In one embodiment, the AR application 216 generates an interactive graphical user interface that the user 120 may use to interact with the AR application 216 and/or control various functions of the computing device 104. In addition, the computing device 104 may translate physical movements and/or gestures, performed by the user 120, as input for the graphical user interface.

The IMU conversion module 218 is configured to convert measurements and/or data obtained by the IMU 304 into one or more inputs usable by the keyboard display module 220. The data obtained by the IMU 304 may be stored as IMU data 236. Using transformation matrices known to one of ordinary skill in the art, the IMU conversion module 218 may execute one or more mathematical operations that transform IMU data 236 into a format or input usable by the keyboard display module 220. Examples of mathematical operations that the IMU conversion module 218 may perform on the IMU data 236 are discussed in the non-patent literature article “A Guide To Using IMU (Accelerometer and Gyroscope Devices) in Embedded Applications” by Sergiu Baluta and available via the Internet at the Uniform Resource Location (URL) of http://www.starlino.com/imu_guide.html, which is incorporated by reference herein in its entirety. The IMU conversion module 218 may convert the IMU data 236 into such information as whether the user 120 is rotating his or her head and the direction of such rotation, an angle at which the user 120 is rotating or moving his or her head, changes in the speed at which the user 120 is moving his or head, and other such rotational and/or acceleration information. As discussed below, this transformed IMU data is used by the keyboard display module 220 in determining those alphanumeric characters the user 120 has selected and/or whether the user 120 intends to select another item provided by the keyboard display module 220.

The keyboard display module 220 is configured to display a graphical keyboard via the display 204 for the user 120 to interact with the computing device 104. In one embodiment, the keyboard display module 220 includes various sub- or internal modules 222-226 that facilitate the display of, and interactions with, the graphical keyboard. In particular, the additional modules include a layout display module 222, a character input module 224, and a character selection module 226.

In addition, the keyboard display module 220 leverages various data 230-234 in displaying the graphical keyboard via the display 204. The data used by the keyboard display module 220 includes one or more keyboard characters 230, one or more keyboard layout(s) 232, and various keyboard thresholds 234, which are used to distinguish between gestures intended to indicate a selection of a character or other input, and those gestures that may be inadvertent or unrelated to the displayed graphical keyboard.

The keyboard characters 230 include those alphanumeric characters. that the keyboard display module 220 may display as selectable alphanumeric characters on a graphical keyboard. In addition, the keyboard characters 230 may include words and/or phrases that also may be displayed as labels for various graphical buttons or other input elements displayed by the keyboard display module 220. Further still, the keyboard characters 230 may include alphanumeric characters, words, and/or phrases in one or more languages, such as English, Russian, Chinese, Hebrew, Arabic, German, and other such languages or combinations of languages. In one embodiment, each set of alphanumeric characters, words, and/or phrases for a particular language are associated with an identifier (e.g., 1=English, 2=German, 3=Chinese, etc.), and the identifier is associated with a selectable and/or changeable user preference. Thus, when the user 120 is using the computing device 104, the user 120 can change the language of the alphanumeric characters, words, and/or phrases displayed on the graphical keyboard by the keyboard display module 220.

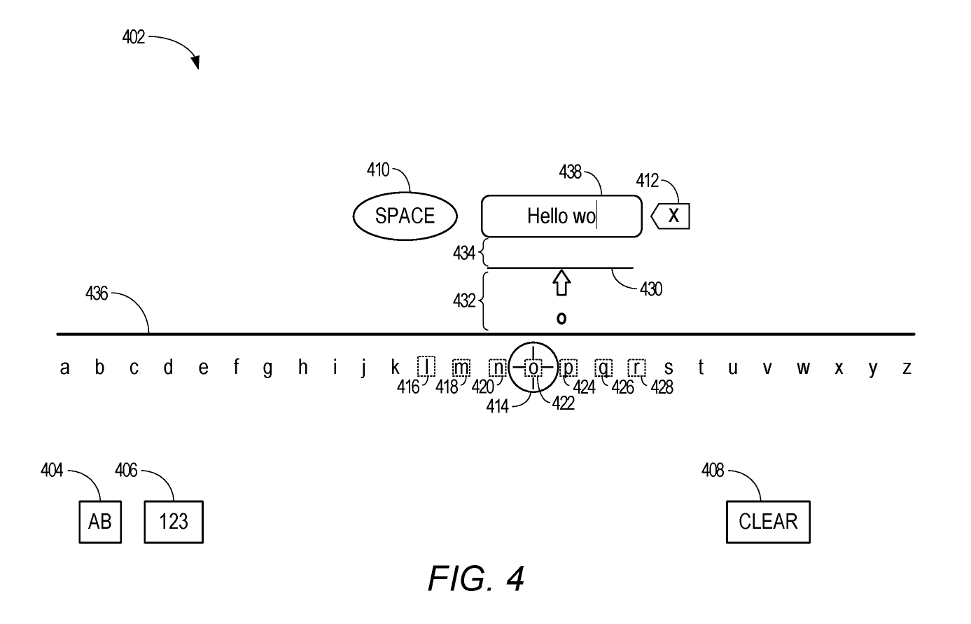

The keyboard layout(s) 232 include one or more configurations (e.g., layouts) that define the manner in which the keyboard display module 220 renders the displayed graphical keyboard. As discussed with reference to FIGS. 4-7, the keyboard layout(s) 232 may define the placement of various graphical elements (e.g., the coordinates on the display 204) associated with a particular layout. As known to one of ordinary skill in the art, the keyboard layout(s) 232 may be defined programmatically in a format understood by the layout display module 222. Further still, the keyboard layout(s) 232 may be associated with a unique or particular identifier, such that the user 120 may select a layout using the unique or particular identifier. The selection of a particular layout may be determined based on IMU data 236 provided by the IMU 304, converted and/or interpreted by the IMU conversion module 218, and then interpreted or understood by one or more modules of the keyboard display module 220, such as the layout display module 222.

The keyboard thresholds 234 include various thresholds that are used by the keyboard display module 220 to distinguish intentional movements to perform a selection by the user 120 and those movements which may be unrelated to the graphical keyboard displayed by the keyboard display module 220. These thresholds may include, but are not limited to, timing thresholds, positional thresholds, angular thresholds, acceleration thresholds, and any other such thresholds or combinations. Examples of thresholds are discussed with reference to the various keyboard layouts illustrated in FIGS. 4-7.

FIG. 4 is a graphical keyboard 402 implemented by the computing device of FIG. 1, according to an example embodiment. As shown in FIG. 4, the graphical keyboard 402 is a linear keyboard where alphanumeric characters of the graphical keyboard 402 are displayed adjacent to one another along a horizontal axis that may be substantially parallel to a ground plane. It should be understood that the graphical keyboard 402 may be displayed on the interior surface of the display 204, which may be a curved surface, such that the graphical keyboard 402 appears to have a slight concave curvature relative to a ground plane. Thus, the illustration in FIG. 4 of the graphical keyboard 402 appearing to be substantially parallel relative to a ground plane is merely illustrative, and various implementations of such graphical keyboard 402 may depart from FIG. 4.

The graphical keyboard 402 displays various input elements for accepting gesture-based input from a user 120 using the computing device 104. These input elements include one or more alphanumeric characters, such as alphanumeric characters 416-428, a graphical button 410 for inserting a blank character (e.g., a “space”), a graphical button 412 for deleting a previously entered character (e.g., a “backspace”), a text field 438 for displaying the alphanumeric characters selected by the user 120, a capitalization button 404 for changing the capitalization (e.g., from lowercase to uppercase or from uppercase to lowercase) of the displayed alphanumeric characters, a numeral button 406 for changing the displayed alphanumeric characters from alphabetic characters to numerical characters (and vice versa), and a clear button 408 for clearing (e.g., deleting) the alphanumeric characters displayed in text field 438.

The graphical keyboard 402 also includes control elements for facilitating the selection of one or more of the input elements discussed above. These control elements include a reticle 414 for selecting one or more of the input elements, a first dividing element 436 that divides the display of the alphanumeric characters from the text field 438, an activation area 432 for signaling that the user 120 intends to submit a selected alphanumeric character for display in the text field 438, a submission area 434 for signaling that the selected alphanumeric character is to be displayed in the text field 438, and a second dividing element 430 that divides the activation area 432 from the submission area 434.

With reference to FIG. 2, the character selection module 226 and the character input module 224 manage and determine the selection of the input elements. In one embodiment, the character selection module 226 manages the display of the reticle 414 and the movement of the reticle 414 relative to the graphical keyboard 402. The character selection module 226 may control the display of the reticle 414 by translating one or more orientation values from the IMU conversion module 218 to corresponding pixel values of the reticle 414. For example, and without limitation, a predetermined amount of rotational difference may correspond to a predetermined change in pixel values. In this manner, a two-degree orientation difference (e.g., in the X- and/or Y-axis) may result in a three- or five-pixel value difference (e.g., in the corresponding axis). Thus, where the computing device 104 is a head-mounted device, rotations in the user's head result in real-time, or substantially real-time, corresponding changes to the displayed reticle 414.

Furthermore, the character selection module 226 may manage the operational state of the graphical keyboard 402. In particular, the character selection module 226 may control whether the graphical keyboard 402 is in a first state (for input element selection) to a second state (for reticle movement) and vice versa. In one embodiment, the character selection module 226 receives input from the IMU conversion module 218 indicating that the user 120 is moving the computing device 104. For example, the input may be an acceleration and/or orientation vector, which the character selection module 226 may compare with an acceleration vector threshold and/or orientation vector threshold selected from the keyboard thresholds 234. An acceleration vector threshold and/or orientation vector threshold may be established so as to reduce the possibility of false positives resulting from micro-movements or other small movements by the user 120.

Where the acceleration vector and/or orientation vector meet or exceed the acceleration vector threshold and/or orientation vector threshold, this signals to the character selection module 226 that the user 120 is moving the computing device 104 so as to engage in the selection of one or more of the input elements displayed on the graphical keyboard 402. In this scenario, the character selection module 226 may change the operational state of the graphical keyboard 402 so as to move the reticle 414 about the graphical keyboard 402. As discussed above, moving the reticle 414 may include changing the pixel values for where the reticle 414 is to be displayed according to changes in the orientation and/or acceleration information provided by the IMU conversion module 218.

Where the acceleration vector and/or orientation vector are less than the acceleration vector threshold and/or orientation vector threshold, this signals to the character selection module 226 that the user 120 intends to select an input element with the reticle 414. In this scenario, the character selection module 226 may change the operational state of the graphical keyboard 402 to an input element selection state such that a given input element appears selected by the reticle 414. Where the input element is an alphanumeric character, such as one of alphanumeric characters 416-428, the alphanumeric character may appear in the activation area 432. Where an input element is one or more of the buttons 404-408, a word and/or phrase corresponding to the selected button (e.g., “AB,” “123,” “CLEAR,” etc.) may appear in the activation area 432.

In the input element selection state, operation of the graphical keyboard 402 may be further managed by the character input module 224. In one embodiment, the character input module 224 is configured to determine whether a selected input element is a submitted input element. In this context, a submitted input element is an input element associated with an alphanumeric character that is either to appear in the text field 438 or an input element associated with a command that the keyboard display module 220 is to perform (e.g., deletion of previously submitted character, changing the displayed alphanumeric characters from lowercase to uppercase, and so forth).

A selected input element may become a submitted input element when the character input module 224 determines that the reticle 414 has crossed over (or into) one or more of the control elements. More particularly, the character input module 224 may determine that a selected input element is to become a submitted input element when the reticle 414 first traverses across the first dividing element 436 and into the activation area 432, and then the reticle 414 traverses across second dividing element 430 and into the submission area 434. To determine whether the reticle 414 has traversed across the first and/or second dividing elements 436, 430 and into the activation area 432 and/or submission area 434, the character input module 224 may compare one or more pixel values associated with the reticle 414 with one or more pixel values associated with the first dividing element 436, the activation area 432, the second dividing element 430, and the submission area 434. Further still, the character input module 224 may further determine whether the reticle 414 has traversed across and/or entered the activation area 432 and/or submission area 434 within a predetermined time period (such as 0.5 seconds), so as to reduce the possibility of unintended submissions of alphanumeric characters. The predetermined time may be stored as one or more of the keyboard thresholds 234.

As an example, suppose that computing device 104 is a head-mounted device, and the user 120 has initially selected the “o” character 422 with the reticle 414. The user 120 may then move his or her head upward, which causes the IMU 304 to provide one or more acceleration and/or orientation values to the IMU conversion module 218, which, in turn, converts such values into meaningful vectors for input to the keyboard display module 220. Using the input provided by the IMU conversion module 218, the character selection module 226 and/or the character input module 224 may then convert such vectors into a vertical movement of the reticle 414, causing the reticle 414 to appear to move from a first position associated with the “o” character 422 to a position corresponding to the input provided by the IMU conversion module 218. In this example, further suppose that such position is associated with one or more pixel values of the activation area 432. The character input module 224 then begins a timer to determine whether the reticle 414 moves from the activation area 432 to the submission area 434 within the predetermined time. Where the input provided by the IMU conversion module 218 further causes the reticle 414 to appear to vertically move to a position associated with the submission area 434 within the predetermined time period, the character input module 224 then interprets such movement as a submission of the “o” character 422 as an alphanumeric character to appear in the text field 438. Thus, the selected input element (e.g., the “o” character 422) becomes a submitted input element. The foregoing actions may occur within a relatively short time (e.g., 0.4 seconds), such that the movement of the reticle 414 appears relatively simultaneous with the head movements performed by the user 120.

In this manner, the character selection module 226 and the character input module 224 operate cooperatively to provide a seamless interaction between the user 120 and the displayed graphical keyboard 402. Furthermore, because the IMU conversion module 218 operates on a near real-time basis with the values being provided by the IMU 304, the user's interactions with the displayed graphical keyboard 402 appear to cause near simultaneous and corresponding changes in the displayed graphical keyboard 402. Finally, because the selection and submission of input elements are associated with natural movements of the user 120, the user 120 experiences less fatigue and fewer delays with the gesture-based graphical keyboard 402 than other types of displayed keyboards.

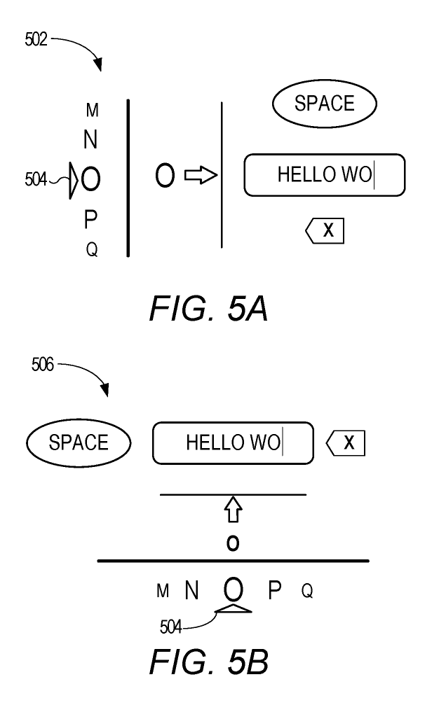

As mentioned briefly above, the graphical keyboard 402 illustrated in FIG. 4 depicts one type of layout from among the possible layouts stored in the keyboard layout(s) 232. FIGS. 5A-5B illustrate alternative examples of graphical keyboards implemented by the computing device of FIG. 1, according to example embodiments. In one embodiment, keyboard layout(s) 232 define a vertically compact graphical keyboard 502 and a horizontally compact graphical keyboard 506. With the graphical keyboards 502, 506, a predetermined number of alphanumeric characters are displayed that is less than a total displayable number of predetermined alphanumeric characters. For example, and as shown in FIGS. 5A-5B, the displayed alphanumeric characters may include five alphanumeric characters from a possible 26 alphanumeric characters. In addition, the keyboard display module 220 may graphically depict the alphanumeric characters of the keyboards 502, 506 in varying font sizes to emphasize a particular alphanumeric character. In one embodiment, each position in which an alphanumeric character is displayed is associated with a particular font or point size, and the keyboard display module 220 displays the alphanumeric character in given position with the corresponding font or point size. As one example, and assuming that a leftmost (or topmost) position is the first position, the first position may be associated with a six point font size, the second position may be associated with an eight point font size, the third (or middle) position may be associated with a ten point font size, the fourth position may be associated with an eight point font size, and the fifth (or rightmost/bottommost) position may be associated with a six point font size. In this manner, the user 120 can readily identify the middlemost alphanumeric character as such alphanumeric character may have the largest point font size.

Further still, the vertically compact graphical keyboard 502 layout and/or horizontally compact graphical keyboard 506 layout may define an indicator element 504 that indicates which alphanumeric character is being selected. The indicator element 504 may be colored differently than the other alphanumeric characters such that the indicator element 504 stands apart from the other alphanumeric characters. The indicator element 504 may further be associated with a particular position, such as the middlemost position of the displayed alphanumeric characters. Thus, the combination of the indicator element 504 and the largest point font size associated with the middlemost alphanumeric character position helps the user 120 quickly identify the middlemost position of the displayed alphanumeric characters. Such identification reduces the possibility of false inputs and erroneously entered alphanumeric characters.

In addition to the manner in which the graphical keyboards 502, 506 are displayed, the manner in which the graphical keyboards 502, 506 operate may be different than the graphical keyboard 402 illustrated in FIG. 4. In particular, and with regard to graphical keyboards 502, 506, the character selection module 226 may change the displayed alphanumeric characters in response to changes in orientation and/or acceleration, which are provided via the IMU conversion module 218.

In one embodiment, the character selection module 226 decrements or increments the displayed alphanumeric characters in response to acceleration and/or orientation information provided via the IMU conversion module 218. In this regard, decrementing the alphanumeric characters means to display one or more alphanumeric characters that occur prior to a given alphanumeric character in a given alphabet, and incrementing the alphanumeric characters means to display one or more alphanumeric characters that occur subsequent to a given alphanumeric character in the given alphabet. In one embodiment, incrementing the displayed alphanumeric characters is associated with a first predefined set of orientation values (e.g., 1°-90°), and decrementing the displayed alphanumeric characters is associated with a second set of predefined set of orientation values (e.g., −1°-−90°. In this embodiment, the zeroth degree may be associated with the user's median plane. Accordingly, where the computing device 104 is a head-mounted device and the displayed alphabet has a reading order of left-to-right, incrementing the displayed alphanumeric characters may be associated with rightward movements of the user's 120 head, and decrementing the displayed alphanumeric characters may be associated with leftward movements of the user's 120 head. Where the reading order of a given alphabet is from right to left, the foregoing orientations, associated degrees, and increments/decrements may be reversed.

In this manner, the keyboard display module 220 is configured to change the displayed alphanumeric characters illustrated in the graphical keyboards 502, 506 of FIGS. 5A-5B. For example, where the displayed alphanumeric characters are “M N O P Q,” and the acceleration and/or orientation data indicate that the character selection module 226 is to increment the displayed alphanumeric characters, the displayed and incremented alphanumeric characters may include “N O P Q R S,” “0 P Q R S T,” “P QRST U,” and so forth. Similarly, where the displayed alphanumeric characters are “M N O P Q” and the acceleration and/or orientation data indicate that the character selection module 226 is to decrement the displayed alphanumeric characters, the displayed and decremented alphanumeric characters may include “L M N O P,” “K L M N O, “J K L M N,” and so forth. Thus, in contrast to using a reticle 414 to select a given alphanumeric character, the user 120 may change which alphanumeric characters are displayed to find and/or select a given alphanumeric character.

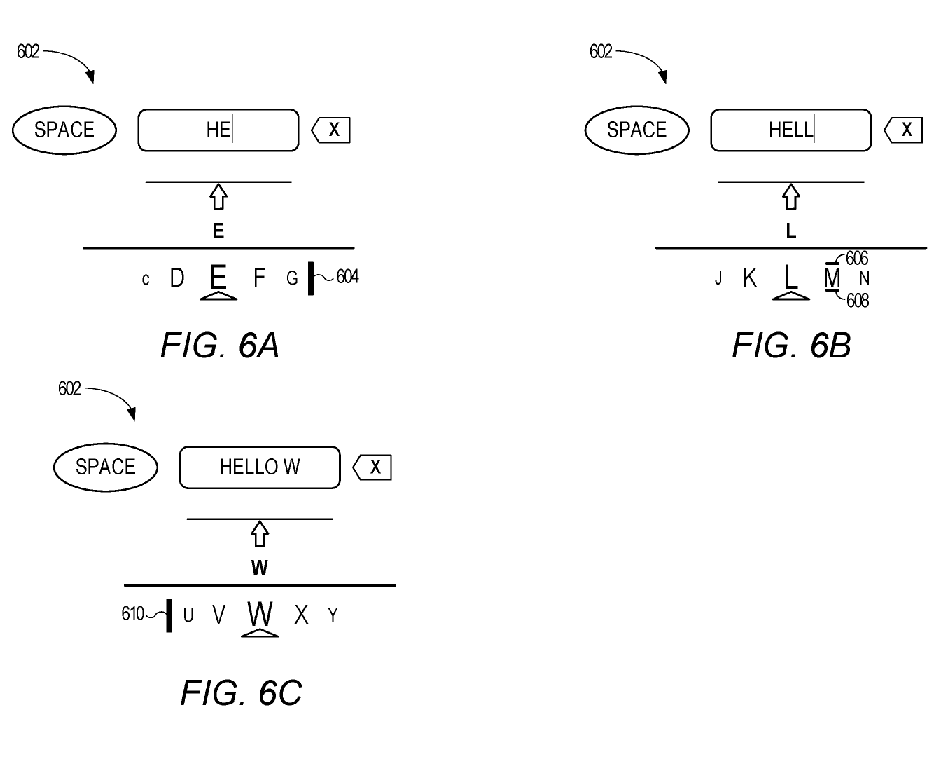

In addition to the indicator element 504, the keyboard display module 220 may be configured to display a median indicator that indicates a median alphanumeric character for a given alphabet. FIGS. 6A-6C illustrate another example of a graphical keyboard 602 implemented by the computing device 104 of FIG. 1, according to example embodiments, where the graphical keyboard 602 further displays various median indicators 604-610 associated with a median alphanumeric character. In the examples shown in FIGS. 6A-6C, the keyboard display module 220 is configured to change the display of a given median indicator depending on the location of the median alphanumeric character in the alphabet relative to the displayed alphanumeric characters. As shown in FIGS. 6A-6C, the median alphanumeric character for the English alphabet is the “M” character; thus, one or more median indicators 604-610 are associated with the “M” character and indicate where the “M” character occurs relative to the displayed alphanumeric characters. In the example illustrated in FIG. 6A, the “M” character occurs subsequent to the displayed “G” character; thus, the median indicator 604 is displayed subsequent to the “G” character. In the example illustrated in FIG. 6B, the “M” character is in a position to be displayed with other alphanumeric characters; thus, median indicators 606-608 identify the “M” character in-line with other alphanumeric character. Finally, in the example illustrated in FIG. 6C, the “M” character occurs prior to the “U” character; thus, the median indicator 610 is displayed preceding the “U” character.

In one embodiment, the keyboard display module 220 is configured to display one or more of the median indicators 604-610 by comparing an alphabetic position associated with a designated median alphanumeric character with one or more alphabetic positions associated with the displayed alphanumeric characters of the graphical keyboard. In this embodiment, where the alphabetic position of the median alphanumeric character precedes the alphabetic position of the first displayed alphanumeric character of the graphical keyboard 602, the keyboard display module 220 is configured to display the median indicator 610. Similarly, where the alphabetic position of the median alphanumeric character is subsequent to the alphabetic position of the last displayed alphanumeric character of the graphical keyboard 602, the keyboard display module 220 is configured to display the median indicator 604. In this manner, the median indicators 604-610 assist the user 120 in readily identifying the median alphanumeric character of a given alphabet, and reduces the amount of time a user 120 may spend in searching for a specific alphanumeric character.

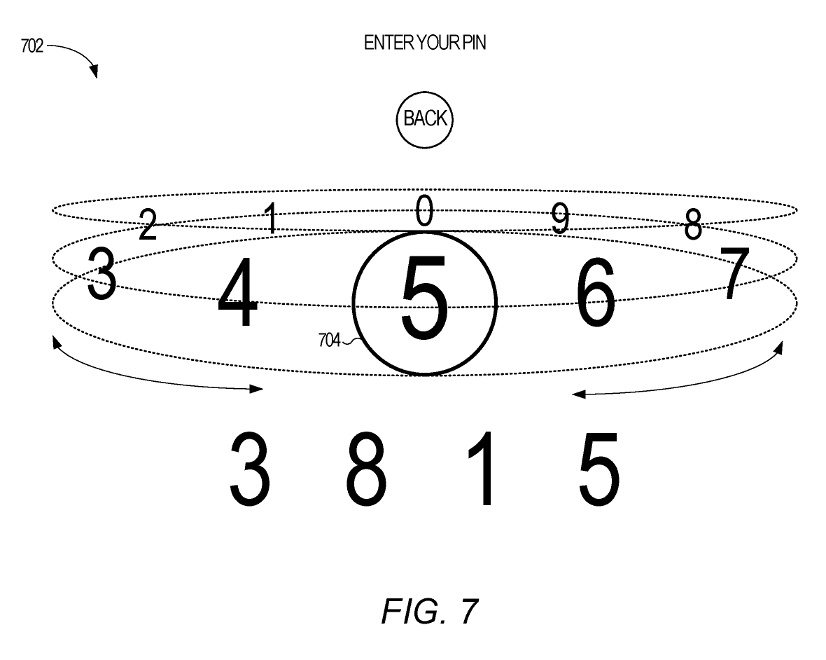

FIG. 7 illustrates another example of a graphical keyboard 702 implemented by the computing device 104 of FIG. 1, according to an example embodiment. In the embodiment illustrated in FIG. 7, the keyboard display module 220 is configured to display the graphical keyboard 702, where the alphanumeric characters of the graphical keyboard 702 are displayed in a “carousel” configuration such that the alphanumeric characters are displayed and sized relative to a selection area 704. The carousel configuration illustrated in FIG. 7 may be defined by one or more of the keyboard layout(s) 232 and selectable by the user 120. Alternatively, and/or additionally, the graphical keyboard 702 may be programmatically selected by the AR application 216.

In one embodiment, each of the positions and font sizes of the displayed alphanumeric characters of the graphical keyboard 702 are proportional to the number of alphanumeric characters displayed. In contrast to the graphical keyboards 502, 506 illustrated in FIGS. 5A-5B, the graphical keyboard 702 may define that a first position within the graphical keyboard 702 is to be associated with the largest font size, and a second position is to be associated with the smallest font size. Positions between the first and second position may then be associated with font sizes increasing from largest to smallest (or smallest to largest). Furthermore, the two-dimensional coordinates (e.g., pixel values) where a given alphanumeric character is to be displayed may be dependent on, and/or proportional to, the number of alphanumeric characters to be displayed with the graphical keyboard 702. In this manner, the alphanumeric characters displayed via the graphical keyboard 702 may appear equidistant relative to one another, and the displayed alphanumeric characters may increase or decrease in font size by proportional amounts.

The graphical keyboard 702 includes a selection area 704 that indicates which of the alphanumeric characters are being selected by the user 120. In one embodiment, the character selection module 226 changes the alphanumeric character within the selection area 704 based on input provided by the IMU 304 and via the IMU conversion module 218. In one embodiment, incrementing the alphanumeric character within the selection area 704 is associated with a first set of orientation and/or acceleration values, and decrementing the alphanumeric character within the selection area 704 is associated with a second set of orientation and/or acceleration values. In this embodiment, the first set of orientation and/or acceleration values may include 1°-90° in a horizontal axis (e.g., the X-axis) and the second set of orientation and/or acceleration values may include −1°-−90° in the horizontal axis (e.g., the X-axis), where 0° is associated with the median plane of the user 120. Thus, where the computing device 104 is implemented as a head-mounted device, the user 120 moving his or her head to the right may cause the alphanumeric character within the selection area 704 to increment (e.g., appear to “rotate” clockwise), and the user 120 moving his or her head to the left may cause the alphanumeric character within the selection area 704 to decrement (e.g., appear to “rotate” counter-clockwise).

In the embodiment of the graphical keyboard 702 illustrated in FIG. 7, the character input module 224 is configured to determine whether a given alphanumeric character within the selection area 704 is to be submitted as input. In one embodiment, the character input module 224 performs this determination by comparing one or more orientation values provided by the IMU conversion module 218 with previously established orientation thresholds. In this embodiment, the orientation thresholds may be established along one or more axes, such as the X-axis, Y-axis, and/or Z-axis such that there is a minimum and/or maximum orientation value threshold in each axis. Further still, the difference between the minimum orientation value threshold and the maximum orientation value threshold in the X-axis and Z-axis may be smaller than the difference between the minimum orientation value threshold and the maximum orientation value threshold in the Y-axis. In this manner, the user 120 is expected to engage in a particular action, such as nodding his or her head along a designated path, to confirm that a given alphanumeric character within the selection area 704 is to be a submitted alphanumeric character.

Furthermore, by varying the difference between the minimum orientation value threshold and the maximum orientation value threshold in one or more axes, the user 120 can be expected to engage in different types of actions to perform different commands. Thus, one or more of the graphical keyboards illustrated in FIGS. 4-7 can be configured to expect the user 120 to engage in particular types of behavior to effectuate alphanumeric character selection and submission. Accordingly, the use of a minimum orientation value threshold and a maximum orientation value threshold is not limited to the graphical keyboard 702 illustrated in FIG. 7, but can be implemented in any one of the graphical keyboards described herein.

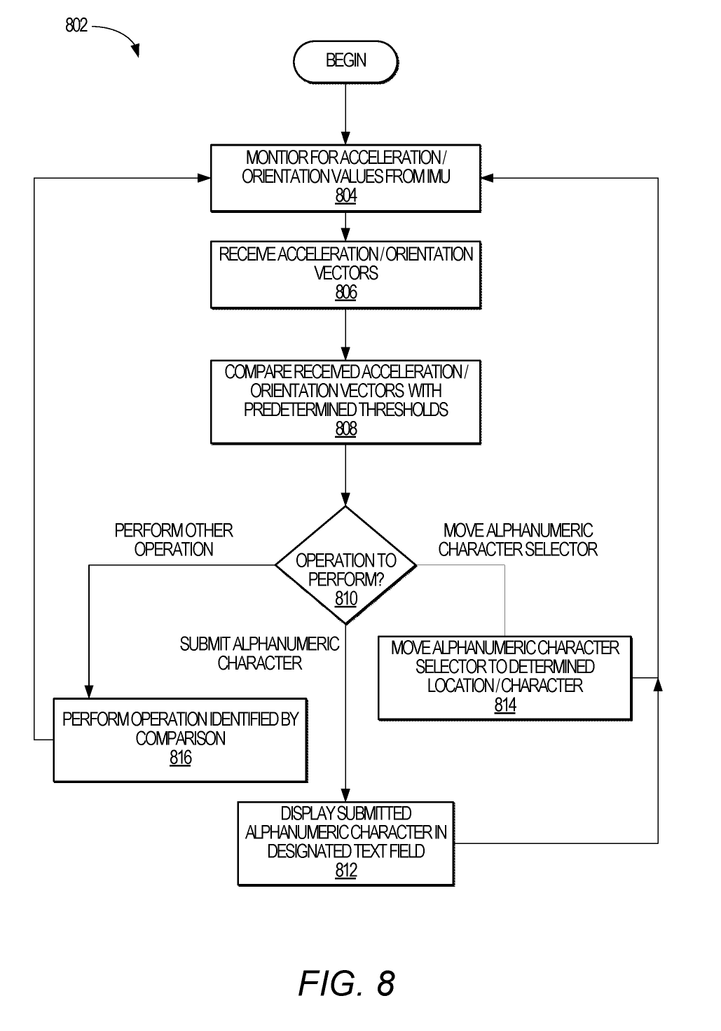

FIG. 8 illustrates a method 802, according to an example embodiment, implemented by the computing device 104 of FIG. 1 for interacting with a displayed graphical keyboard. The method 802 may be implemented by one or more components of the computing device 104 as illustrated in FIG. 1 and is discussed by way of reference thereto.

Initially, the character selection module 226 monitors for one or more acceleration and/or orientation values obtained by the IMU 304 (Operation 804). As discussed above, where the computing device 104 is a head-mounted device, head movements by the user 120 may cause the IMU 304 to record various measurements in one or more axes (e.g., X-axis, Y-axis, and/or Z-axis). As explained previously, such values may be stored as the IMU data 236. The IMU 304 may then communicate the obtained measurements to an IMU conversion module 218 to convert the obtained measurements from raw values as acquired by the IMU 304 to meaningful vectors for input to the keyboard display module 220. Such vectors may include one or more acceleration vectors and/or one or more orientation vectors. Additionally, and/or alternatively, the IMU 304 may provide the obtained measurements in a vector form, or the keyboard display module 220 may perform the operations to convert the raw measurements acquired by the IMU 304 to vector form. After the IMU conversion module 218 converts the obtained measurements to the one or more vectors, the keyboard display module 220 then receives the vectors from the IMU conversion module 218 (Operation 806). The keyboard display module 220 then compares the received vectors with one or more corresponding keyboard thresholds 234 to determine which commands to perform via the graphical keyboard (Operation 808).

Using the received vectors, one or more modules of the keyboard display module 220 determines whether to perform an operation and/or command in response to the received vectors (Operation 810). In one embodiment, and as explained above, the character selection module 226 and the character input module 224 compare the values of the received vectors with previously established value thresholds 234 associated with particular commands and/or operations. Each command and/or operation, such as a command to move an alphanumeric character selector (e.g., the reticle 414) or an operation to change the displayed alphanumeric characters, may be associated with a minimum value threshold and a maximum value threshold for one or more axes of movement. The minimum value threshold and/or the maximum value threshold may represent orientation, movement, acceleration, and so forth.

Where the vector values for a given vector and/or a plurality of vectors are within the threshold values for a given command and/or operation, the character selection module 226 and/or the character input module 224 interprets the movement associated with such vector values as commands or operations to perform. In one embodiment, the character selection module 226 and/or the character input module 224 may be configured with conditional logic that determines whether the movements associated with the user 120 are movements associated with a command and/or operation to perform. In this manner, movements associated with a command or operation are distinguishable from movements associated with general use or operation of the computing device 104.

Where the movements of the computing device 104 are determined to be a command or operation to select an alphanumeric character, the method 802 proceeds to Operation 814. At Operation 814, the keyboard display module 220 causes a change in the displayed graphical keyboard to reflect that the user 120 is selecting an alphanumeric character. For example, and with reference to FIG. 4, the keyboard display module 220 may display movements and/or changes in the reticle 414 that correspond with movements by the user 120. Similarly, and with reference to FIGS. 5A-5B, the keyboard display module 220 may causes changes to one or more of the displayed alphanumeric characters, such as by increasing and/or decreasing their size and shifting (e.g., incrementing or decrementing) which alphanumeric characters are displayed. The method 802 then returns to Operation 804, where the keyboard display module 220 awaits further input from the IMU 304.

Where the movements of the computing device 104 are determined to be a command or operation to submit an alphanumeric character, the method 802 proceeds to Operation 812. At Operation 812, the keyboard display module 220 causes a change in the displayed graphical keyboard to reflect that the user 120 has submitted an alphanumeric character. For example, and with reference to FIG. 4, the keyboard display module 220 may display a selected alphanumeric character in the text field 438. Similarly, and with reference to FIGS. 5A-5B, the keyboard display module 220 may display a selected alphanumeric character in an associated and displayed text field. The method 802 then returns to Operation 804, where the keyboard display module 220 awaits further input from the IMU 304.

The movements of the computing device 104 may also be associated with other commands and/or operations other than selecting an alphanumeric character or submitting a selected alphanumeric character. Accordingly, where the movements of the computing device 104 are determined to be associated with another command and/or operation, the method 802 proceeds to Operation 816. At Operation 816, one or more modules of the computing device 104, such as the AR application 216 and/or the keyboard display module 220, performs the command and/or operation associated with the determined command and/or operation. Examples of other operations and/or commands include executing a selected application, requesting additional information for a detected object, opening and/or closing one or more menus for interacting with the computing device 104, and other such operations and/or commands. After performing the determined command and/or operation, the method 802 returns to Operation 804, where the keyboard display module 220 awaits further input from the IMU 304.

In this manner, this disclosure provides for a computing device 104 configured to display a graphical keyboard on a display 204 of the computing device 104, where the user 120 can provide input to manipulate the displayed graphical keyboard through movements of the user's body on which the computing device 104 is being worn. As discussed above, the computing device 104 includes an IMU 304, which gathers measurements along various axes of movement. These measurements are then converted to vectors, which are then provided as input to a keyboard display module 220. The keyboard display module 220 then interprets the movements as selections and/or submissions of one or more alphanumeric characters and/or commands displayed by the graphical keyboard. One technical benefit provided by the disclosed graphical keyboard is that it creates a human/machine interface that allows the user 120 to interact with the computing device 104 and to provide input to the computing device 104 without having to use a traditional, hardware keyboard or other physical input device (e.g., a mouse).

In addition, this disclosure includes various implementations of the disclosed graphical keyboard, where the various implementations provide a benefit to the user depending on the implementation of the computing device 104. For example, the graphical keyboards 502, 506 and/or the graphical keyboard 602 may be implemented in a computing device 104 where the area in which the graphical keyboard is displayable is limited or the area designated for the keyboard on the display 204 is limited. Alternatively, the graphical keyboard 402 may be implemented where the area of display for the graphical keyboard 402 is a larger area. Furthermore, the keyboard display module 220 may be configured to switch between the various graphical keyboards disclosed herein to correspond with the display area available for displaying the graphical keyboard. Thus, this disclosure provides a computing device 104 that has a number of technical benefits to human/machine interfaces over previous, traditional hardware-based solutions.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 802 illustrated in FIG. 8. Additionally, or alternatively, the instructions 916 may implement one or more of the modules 212 illustrated in FIG. 2 and so forth. The instructions 916 transform the general, non-programmed machine into a particular machine programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory/storage 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 912 and processor 914 that may execute instructions 916. The term “processor” is intended to include a multi-core processor that may comprise two or more independent processors (sometimes referred to as “cores”) that may execute instructions 916 contemporaneously. Although FIG. 9 shows multiple processors 910, the machine 900 may include a single processor with a single core, a single processor with multiple cores (e.g., a multi-core process), multiple processors with a single core, multiple processors with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of processors 910 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962 among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via coupling 982 and coupling 972 respectively. For example, the communication components 964 may include a network interface component or other suitable device to interface with the network 980. In further examples, communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a Universal Serial Bus (USB)).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to devices 970. The term “transmission medium” shall be taken to include any intangible medium that is capable of storing, encoding, or carrying instructions 916 for execution by the machine 900, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

We claim:

1. A computing device for displaying a graphical keyboard, the computing device comprising:
a machine-readable memory storing computer-executable instructions; and
at least one hardware processor in communication with the machine-readable memory that, when the computer-executable instructions are executed, configures a computing device to perform a plurality of operations, the plurality of operations comprising:
displaying, on a transparent display physically coupled with the at least one hardware processor, a graphical keyboard, the graphical keyboard having at least one selectable alphanumeric character;
acquiring, by at least one inertial measurement unit, a plurality of measurements indicating user movement of the computing device;
converting, by the at least one hardware processor, the plurality of measurements to obtain a plurality of vectors, at least one vector of the plurality of vectors associated with at least three axes of movement;
determining, by the at least one hardware processor, and based on the plurality of vectors, a command to perform with the displayed graphical keyboard; and
performing, by the at least one hardware processor, the determined command with the displayed graphical keyboard.

2. The computing device of claim 1, wherein the plurality of operations further comprises:
comparing one or more values of the plurality of vectors with a plurality of corresponding thresholds, at least one of the thresholds selected from the plurality of thresholds associated with the command to perform; and
the determining of the command to perform is further based on the comparison.

3. The computing device of claim 1, wherein the command to perform comprises a command to select the at least one selectable alphanumeric character.

4. The computing device of claim 1, wherein:
the command to perform comprises a command to submit the at least one selectable alphanumeric character; and
the plurality of operations further comprises displaying the submitted at least one selectable alphanumeric character at a predetermined location of the graphical keyboard.

5. The computing device of claim 1, wherein:
the displayed graphical keyboard comprises:
a horizontal arrangement of alphanumeric characters, the horizontal arrangement of alphanumeric characters being substantially parallel to a ground plane; and
at least one control element that indicates whether the user intends to submit the at least one selectable alphanumeric character for display on the transparent display physically coupled with the at least one hardware processor.

6. The computing device of claim 1, wherein:
the displayed graphical keyboard comprises:
a first plurality of alphanumeric characters, the first plurality of alphanumeric characters being a subset selected from a second plurality of alphanumeric characters, wherein each alphanumeric character of the first plurality of alphanumeric characters is displayed in a font size based on a relative position of the alphanumeric character; and
an indicator element that indicates an alphanumeric character selected from the first plurality of alphanumeric characters to be a submitted alphanumeric character, wherein the indicator element is associated with a predetermined position where the first plurality of alphanumeric characters are displayed.

7. The computing device of claim 1, wherein:
the displayed graphical keyboard comprises:
an elliptical arrangement of a plurality of alphanumeric characters, wherein:
a first position of the elliptical arrangement is associated with a largest font size and a second position is associated with a smallest font size;
each alphanumeric character of the plurality of alphanumeric characters is displayed at a two-dimensional coordinate relative to the transparent display physically coupled with the at least one hardware processor;
a first alphanumeric character of the plurality of alphanumeric characters is displayed with the largest font size at the first position;
a second alphanumeric character of the plurality of alphanumeric characters is displayed with the smallest font size at the second position; and
a set of alphanumeric characters selected from the plurality of alphanumeric characters, where each alphanumeric characters of the set is displayed with a font size having a value between the smallest font size and the largest font size.

8. A method for displaying a graphical keyboard on a computing device, the method comprising:
displaying, on a transparent display physically coupled with at least one hardware processor, a graphical keyboard, the graphical keyboard having at least one selectable alphanumeric character;
acquiring, by at least one inertial measurement unit, a plurality of measurements indicating user movement of the computing device;
converting, by the at least one hardware processor, the plurality of measurements to obtain a plurality of vectors, at least one vector of the plurality of vectors associated with at least three axes of movement;
determining, by the at least one hardware processor, and based on the plurality of vectors, a command to perform with the displayed graphical keyboard; and
performing, by the at least one hardware processor, the determined command with the displayed graphical keyboard.

9. The method of claim 8, wherein the method further comprises:
comparing one or more values of the plurality of vectors with a plurality of corresponding thresholds, at least one of the thresholds selected from the plurality of thresholds being associated with the command to perform; and
the determining of the command to perform is further based on the comparison.

10. The method of claim 8, wherein the command to perform comprises a command to select the at least one selectable alphanumeric character.

11. The method of claim 8, wherein:
the command to perform comprises a command to submit the at least one selectable alphanumeric character; and
the method further comprises displaying the submitted at least one selectable alphanumeric character at a predetermined location of the graphical keyboard.

12. The method of claim 8, wherein:
the displayed graphical keyboard comprises:
a horizontal arrangement of alphanumeric characters, the horizontal arrangement of alphanumeric characters being substantially parallel to a ground plane; and
at least one control element that indicates whether the user intends to submit the at least one selectable alphanumeric character for display on the transparent display physically coupled with the at least one hardware processor.

13. The method of claim 8, wherein:
the displayed graphical keyboard comprises:
a first plurality of alphanumeric characters, the first plurality of alphanumeric characters being a subset selected from a second plurality of alphanumeric characters, wherein each alphanumeric character of the first plurality of alphanumeric character is displayed in a font size based on a relative position of the alphanumeric character; and
an indicator element that indicates an alphanumeric character selected from the first plurality of alphanumeric characters to be a submitted alphanumeric character, wherein the indicator element is associated with a predetermined position where the first plurality of alphanumeric characters are displayed.

14. The method of claim 8, wherein:
the displayed graphical keyboard comprises:
an elliptical arrangement of a plurality of alphanumeric characters, wherein:
a first position of the elliptical arrangement is associated with a largest font size and a second position is associated with a smallest font size;
each alphanumeric character of the plurality of alphanumeric characters is displayed at a two-dimensional coordinate relative to the transparent display physically coupled with the at least one hardware processor;
a first alphanumeric character of the plurality of alphanumeric characters is displayed with the largest font size at the first position;
a second alphanumeric character of the plurality of alphanumeric characters is displayed with the smallest font size at the second position; and
a set of alphanumeric characters selected from the plurality of alphanumeric characters, where each alphanumeric character of the set is displayed with a font size having a value between the smallest font size and the largest font size.

15. A computer-readable medium having computer-executable instructions stored thereon that, when executed by at least one hardware processor, causes a computing device to perform a plurality of operations, the plurality of operations comprising;
displaying, on a transparent display physically coupled with the at least one hardware processor, a graphical keyboard, the graphical keyboard having at least one selectable alphanumeric character;
acquiring, by at least one inertial measurement unit, a plurality of measurements indicating user movement of the computing device;
converting, by the at least one hardware processor, the plurality of measurements to obtain a plurality of vectors, at least one vector of the plurality of vectors associated with at least three axes of movement;
determining, by the at least one hardware processor, and based on the plurality of vectors, a command to perform with the displayed graphical keyboard; and
performing, by the at least one hardware processor, the determined command with the displayed graphical keyboard.

16. The computer-readable medium of claim 15, wherein the plurality of operations further comprises:
comparing one or more values of the plurality of vectors with a plurality of corresponding thresholds, at least one of the thresholds selected from the plurality of thresholds being associated with the command to perform; and
the determining of the command to perform is further based on the comparison.

17. The computer-readable medium of claim 15, wherein:
the command to perform comprises a command to submit the at least one selectable alphanumeric character; and
the plurality of operations further comprises displaying the submitted at least one selectable alphanumeric character at a predetermined location of the graphical keyboard.

18. The computer-readable medium of claim 15, wherein:
the displayed graphical keyboard comprises:
a horizontal arrangement of alphanumeric characters, the horizontal arrangement of alphanumeric characters being substantially parallel to a ground plane; and
at least one control element that indicates whether the user intends to submit the at least one selectable alphanumeric character for display on the transparent display physically coupled with the at least one hardware processor.

19. The computer-readable medium of claim 15, wherein:
the displayed graphical keyboard comprises:
a first plurality of alphanumeric characters, the first plurality of alphanumeric characters being a subset selected from a second plurality of alphanumeric characters, wherein each alphanumeric character of the first plurality of alphanumeric character is displayed in a font size based on a relative position of the alphanumeric character; and
an indicator element that indicates an alphanumeric character selected from the first plurality of alphanumeric characters to be a submitted alphanumeric character, wherein the indicator element is associated with a predetermined position where the first plurality of alphanumeric characters are displayed.

20. The computer-readable medium of claim 15, wherein:
the displayed graphical keyboard comprises:
an elliptical arrangement of a plurality of alphanumeric characters, wherein:
a first position of the elliptical arrangement is associated with a largest font size and a second position is associated with a smallest font size;
each alphanumeric character of the plurality of alphanumeric characters is displayed at a two-dimensional coordinate relative to the transparent display physically coupled with at least one hardware processor;
a first alphanumeric character of the plurality of alphanumeric characters is displayed with the largest font size at the first position;
a second alphanumeric character of the plurality of alphanumeric characters is displayed with the smallest font size at the second position; and
a set of alphanumeric characters selected from the plurality of alphanumeric characters, where each alphanumeric character is displayed with a font size having a value between the smallest font size and the largest font size.
